(19) United States
(12) Patent Application Publication
(10) Pub. No.: US 2010/0144505 A1
(43) Pub. Date: Jun. 10, 2010

(54) ROLLER USABLE WITH IMAGE FORMING APPARATUS AND METHOD OF MANUFACTURING THE SAME

(75) Inventor: Yong-hun Kim, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/485,139

(22) Filed: Jun. 16, 2009

(30) Foreign Application Priority Data
Dec. 9, 2008 (KR) 2008-124797

(51) Int. Cl. B05C 1/08; G03G 15/08; B23P 11/00

(52) U.S. Cl. 492/18; 399/286; 29/428

(57) ABSTRACT

A roller usable with an image forming apparatus includes a shaft, a body formed on an outer surface of the shaft, and a tube disposed on an outer surface of the body. The tube is formed so that opposite side end portions of the tube contact opposite side surfaces of the body. The opposite side end portions of the tube are heated and pressurized so as to be secured on the opposite side surfaces of the body.

### CROSS-REFERENCE TO RELATED APPLICATIONS

This application claims the benefit under 35 U.S.C. §119(a) from Korean Patent Application No. 2008-124797 filed Dec. 9, 2008 in the Korean Intellectual Property Office, the disclosure of which is incorporated herein by reference in its entirety.

### BACKGROUND

1. Field of the Invention

The present general inventive concept relates to an image forming apparatus. More particularly, the present general inventive concept relates to a roller usable with an electro photographic image forming apparatus and a method of manufacturing the same.

2. Description of the Related Art

Generally, electro photographic image forming apparatuses, such as laser printers, facsimile machines, copiers, etc., include a photosensitive medium, and a charging roller, a developing roller, a transferring roller, etc., disposed around the photosensitive medium. Developer supplied from a developer supplying member is moved by voltages applied to the photosensitive medium, the charging roller, the developing roller, and the transferring roller, thereby forming predetermined images on a printing medium.

For example, the charging roller charges the surface of the photosensitive medium by a predetermined voltage, and an exposing unit scans a light onto the charged surface of the photosensitive medium to form electrostatic latent images corresponding to printing data thereon. Then, the developing roller supplies developer to the photosensitive medium and develops the electrostatic latent images into developer images. The developer images are transferred onto the printing medium passing between the photosensitive medium and the transferring roller by the transferring roller. At this time, predetermined voltages are applied to the charging roller, the developing roller, and the transferring roller, respectively.

Therefore, rollers usable with the image forming apparatus, such as the developing roller, the charging roller, the transferring roller, etc., need to have conductivity. Also, although the rollers are used for a long time, change of the conductivity of the rollers is required to be small. The present general inventive concept relates to rollers usable with an image forming apparatus to which voltages are applied and a method of manufacturing the same.

### SUMMARY

The present general inventive concept may relate to a roller usable with an image forming apparatus of which a tube is stably secured to a body of the roller and a method of manufacturing the same.

Additional aspects and utilities of the present general inventive concept will be set forth in part in the description which follows and, in part, will be obvious from the description, or may be learned by practice of the general inventive concept.

The foregoing and/or other aspect and utilities of the present general inventive concept can substantially be achieved by providing a roller usable with an image forming apparatus, which includes a shaft; a body formed on an outer surface of the shaft; and a tube disposed on an outer surface of the body, the tube formed so that opposite side end portions of the tube contact opposite side surfaces of the body.

The opposite side end portions of the tube may be heated and pressurized so as to be secured on the opposite side surfaces of the body.

The opposite side end portions of the tube may be formed so that a section of a corner thereof is a round shape.

The opposite side ends of the tube may project by a predetermined length from the opposite side surfaces of the body, and contact the opposite side surfaces of the body, wherein the predetermined length is within a range between about 1 mm and a distance from an outer surface of the body to an outer surface of the shaft.

The body may be disposed on the shaft by an insert extrusion molding.

The tube may be disposed on the body by an insert extrusion molding.

The tube may be formed of at least one material selected from the group consisting of ethylene propylene diene monomer rubber (EPDM), acrylonitrile butadiene rubber (NBR), polyolefin resin, fluoro based polymeric resin, and any mixture thereof.

The tube may have a hardness higher than that of the body and the hardness of the tube may be about 35 to about 45 degrees (Asker type-A).

An electric resistance of the tube may be about 10⁵Ω to about 10⁶Ω, and an entire electric resistance of the roller may be about 10⁶Ω to about 3.5×10⁶Ω.

The tube may have a surface roughness of Rz 7-11 μm and a thickness of 2.5±0.5 mm.

The roller may include a developing roller, a charging roller, a transferring roller, a charge cleaning roller, and a reset roller.

The foregoing and/or other aspects and utilities of the present general inventive concept can also be achieved by providing a method of manufacturing a roller usable with an image forming apparatus, which may include forming a shaft and a body integrally with each other so that the shaft is located at a center of the body; forming a tube on an outer surface of the body so that opposite side ends of the tube project from opposite side surfaces of the body; and attaching projecting opposite side end portions of the tube on the opposite side surfaces of the body.

The attaching projecting opposite side end portions of the tube on the opposite side surfaces of the body may include using a side end attaching jig so that the projecting opposite side end portions of the tube are deformed and contact the opposite side surfaces of the body; and applying heat to the side end attaching jig.

The forming a tube so that opposite side ends of the tube project from opposite side surfaces of the body may include allowing the opposite side ends of the tube to project from the opposite side surfaces of the body within a range between about 1 mm and a distance from an outer surface of the body to an outer surface of the shaft.

The forming a shaft and a body integrally with each other may include an insert extrusion molding in that the shaft is inserted in an extrusion die and the body is extruded.

The forming a tube on an outer surface of the body may include an insert extrusion molding in that the body having the shaft is inserted in an extrusion die and the tube is extruded.

The foregoing and/or other aspects and utilities of the present general inventive concept can also be achieved by providing a roller usable with an image forming apparatus, the roller including an integrally formed shaft and body, the shaft being formed at and extending out from a center of the body; and a tube disposed on an outer surface of the body and folded over opposite side end portions of opposite side surfaces of the body by a predetermined amount to be adhered thereto.

### BRIEF DESCRIPTION OF THE DRAWINGS

These and/or other aspects and utilities of the present general inventive concept will become apparent and more readily appreciated from the following description of the embodiments, taken in conjunction with the accompanying drawings of which:

FIG. 1 is a perspective view illustrating a roller usable with an image forming apparatus according to an embodiment of the present general inventive concept;

FIG. 2 is a side view illustrating the roller usable with an image forming apparatus of FIG.1;

FIG. 3 is a sectional view illustrating the roller usable with an image forming apparatus of FIG. 1 taken along a line 3-3 in FIG. 1;

FIG. 4 is a partial sectional view illustrating the roller usable with an image forming apparatus of FIG. 1 taken along a line 4-4 in FIG. 1;

FIG. 5 is a perspective view illustrating a side end attaching jig to mold opposite side ends of a roller usable with an image forming apparatus according to an embodiment of the present general inventive concept;

FIG. 6A is a sectional view illustrating a roller having a tube projecting from a side end thereof and a side end attaching jig;

FIG. 6B is a sectional view illustrating a roller having a tube of which a side end is being molded by a side end attaching jig;

FIG. 7 is a flow chart illustrating a method of manufacturing a roller usable with an image forming apparatus according to an embodiment of the present general inventive concept; and

FIG. 8 is a flow chart illustrating a method of manufacturing a developing roller usable with an image forming apparatus according to an embodiment of the present general inventive concept using an extrusion molding process.

### DETAILED DESCRIPTION OF THE EMBODIMENTS

Reference will now be made in detail to the embodiments of the present general inventive concept, examples of which are illustrated in the accompanying drawings, wherein like reference numerals refer to the like elements throughout. The embodiments are described below in order to explain the present general inventive concept by referring to the figures.

The matters defined in the description, such as a detailed construction and elements thereof, are provided to assist in a comprehensive understanding of the present general inventive concept. Thus, it is apparent that the present inventive concept may be carried out without those defined matters. Also, well-known functions or constructions are omitted to provide a clear and concise description of exemplary embodiments herein.

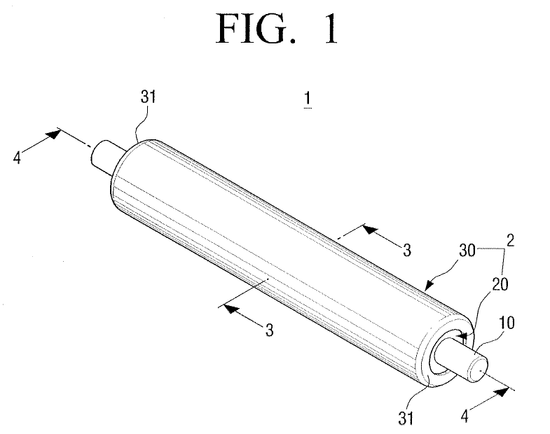

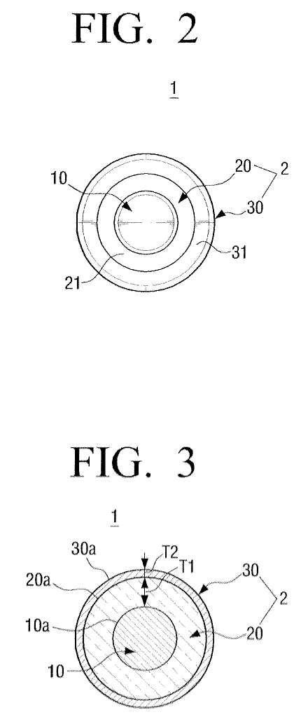

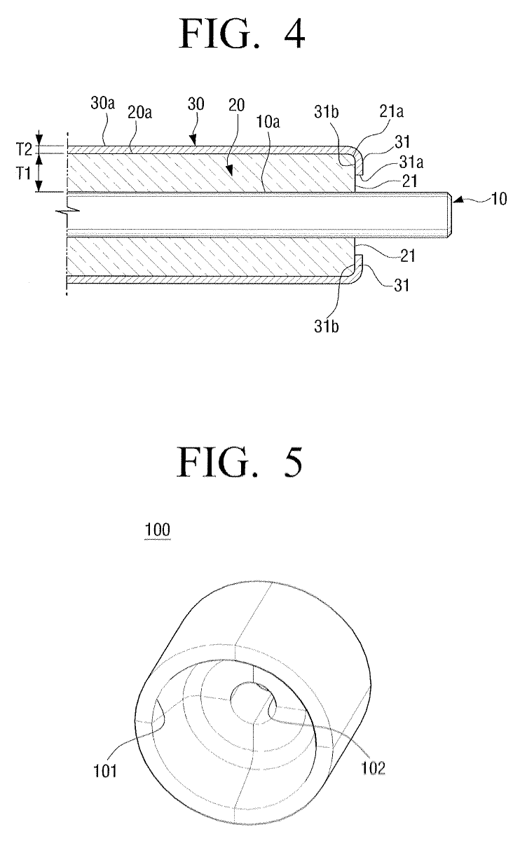

FIG. 1 is a perspective view illustrating a roller 1 usable with an image forming apparatus according to an embodiment of the present general inventive concept. FIG. 2 is a side view illustrating the roller 1 usable with an image forming apparatus of FIG. 1. FIG. 3 is a sectional view illustrating the roller 1 usable with an image forming apparatus of FIG. 1 taken along a line 3-3 in FIG. 1, and FIG. 4 is a partial sectional view illustrating the roller 1 usable with an image forming apparatus of FIG. 1 taken along a line 4-4 in FIG. 1.

Referring to FIGS. 1 to 4, the roller 1 usable with an image forming apparatus according to an embodiment of the present general inventive concept may include a shaft 10 and a roller body 2.

The roller body 2 is fixed to the shaft 10. The shaft 10 is a rotation center of the roller body 2 and may be formed of a metallic material. In this embodiment, the shaft 10 may be formed of at least one material selected among a stainless use machinability (SUM), a steel use stainless (SUS), etc. The shaft 10 may have a diameter of about 4 mm to about 8 mm, and the surface of the shaft 10 may be plated by a nickel, etc.

The roller body 2 may be formed to have specific properties according to usage of the roller 1 for an image forming apparatus and may be formed so that change of the specific properties of the roller body 2, caused by change of environment, is minimized. For example, if the roller 1 is used as a developing roller, the roller body 2 may be formed to have a suitable property to carry developer to the photosensitive medium. If the roller 1 is used as a charging roller, the roller body 2 may be formed to have a suitable property to charge the photosensitive medium. If the roller 1 is used as a transferring roller, the roller body 2 may be formed to have a suitable property to transfer developer images onto a printing medium.

For example, when the roller 1 according to an embodiment of the present general inventive concept is used as a developing roller for an image forming apparatus, the roller body 2 may have properties as described below.

In general, the developing roller usable with an image forming apparatus receives developer from a developer supplying apparatus, and then supplies the developer to the photosensitive medium by a mechanical force and/or an electrostatic force. The developing roller may be formed of a rubber material. The developing roller may be formed of at least one material selected among silicone rubber, acrylonitrile butadiene rubber (NBR), polyurethane, ethylene propylene diene monomer rubber (EDPM), etc.

Rubbers that have been currently mainly used may have strong polarity characteristics and a lot of substituents. Therefore, in an ion conduction type roller an electric resistance thereof may greatly change according to an environmental change. For example, a difference between the volume resistances of the roller in a high temperature-high humidity environment and in a low temperature-low humidity environment may be approximately 10²Ω. Therefore, to minimize an increase of the resistance of the roller in the low temperature-low humidity environment, the roller may be formed to have a low resistance in a normal temperature-normal humidity environment. However, the roller may cause image gradation to be lowered so that a printing quality is deteriorated.

Also, an electron conduction type roller formed to add carbon black to rubber may have a relatively small change of electric resistance with respect to the environmental change. However, it may be difficult to manufacture the roller because of various problems such as, for example, the fact that there are relatively large production deviations among the rollers, the roller may cause developer to be heat deteriorated by the hardness thereof increased excessively, there may be local deviation of electric resistance in the roller, and the electric resistance of the roller may be greatly changed according to the amount of carbon black contained in the roller.

Furthermore, urethane rollers are expensive such that the manufacturing costs of an image forming apparatus using the same are increased. In silicon rollers, materials with low molecular weight may come out of the surface of the silicon roller and contaminate images. When the silicon roller has been used for a long period of time, its durability may be more and more lowered so that the silicon roller may be worn down over time.

For solving such problems as described above, the developing roller may be formed to have a two-layer structure. In other words, to minimize loss of electric field and maintaining image gradation, an inner layer of the developing roller may be formed as an elastic layer of low resistance and an outer layer of the developing roller may be formed of a high resistance material. The developing roller of such a two-layer structure can not only minimize the resistance change thereof according to an environmental change, but can also decrease the electric field loss thereof so as to maintain image gradation.

Furthermore, if the charging roller and the transferring roller are formed in the two-layer structure as described above, the resistance change thereof may be minimized and the electric field losses thereof also may be decreased. In addition, if a charge cleaning roller that contacts and cleans the charging roller, and a reset roller that contacts the surface of the developing roller and cleans or resets developer, such as toner, from the surface of the developing roller are formed in the two-layer structure as described above, manufacturing and applying them may be easy.

Therefore, in the present general inventive concept, the roller body 2 of the roller 1 usable with the image forming apparatus may be formed in the two-layer structure having a body 20 and a tube 30.

The body 20 may be formed of a conductive rubber material with low electric resistance and elasticity. The tube 30 may be formed of a conductive rubber material with high electric resistance. The body 20 may be formed integrally with the shaft 10 on an outer surface 10a of the shaft 10. In other words, the body 20 may be formed substantially in a cylindrical shape with a hollow in which the shaft 10 can be inserted. The shaft 10 may be inserted into and fixed to the hollow of the body 20. Therefore, the shaft 10 may be located at the center of the body 20.

The body 20 may be formed by either an extrusion molding method using an extruding machine or a press molding method using a press. The extrusion molding method uses the extruding machine to mold the body 20. The extrusion molding method is a method in that raw materials are inputted into an inside of a cylinder of the extruding machine, are forcibly conveyed by a screw, are passed through an injection die or an extrusion die, and are formed in a body 20 having a desired shape. The shape and size of the body 20 is determined by the injection die or the extrusion die. The press molding method is a method in that after press dies having desired size and shape are manufactured, raw materials are inputted into the press dies and predetermined heat and pressure are applied to the raw materials so that the raw materials are formed in a body 20 having a desired shape. Also, because the mixed materials of the body 20 molded by the extrusion molding method are in an unvulcanized state, the mixed materials of the body 20 are caused to react at a predetermined temperature and pressure using a vulcanizing pipe so that the body 20 has a three-dimensional reticulated structure. As a result, a conductive body 20 having elasticity may be produced.

When the body 20 and the shaft 10 are integrally formed with each other, the body 20 and the shaft 10 may be separately manufactured, and then the shaft 10 may be inserted into the body 20. Also, during the extrusion molding process or the press molding process, the shaft 10 may be inserted in the injection die or the press dies so that the shaft 10 may be molded integrally with the body 20. The shaft 10 and the body 20 may be adhered to each other using adhesives as desired. The body 20 may be formed to have a thickness of about 2 mm to about 8 mm on the surface of the shaft 10.

The tube 30 may be disposed on an outer surface 20a of the body 20. As illustrated in FIGS. 2 and 4, opposite side end portions 31 of the tube 30 may be formed to contact opposite side surfaces 21 of the body 20 (or opposite side ends of the body). In other words, the tube 30 may be formed so that an inner surface 31b of a portion 31 of the tube 30 adjacent each of opposite side ends 31a of the tube 30 contacts each of the opposite side surfaces 21 of the body 20. In FIGS. 2 and 4, only one side end portion 31 of the tube 30 is illustrated.

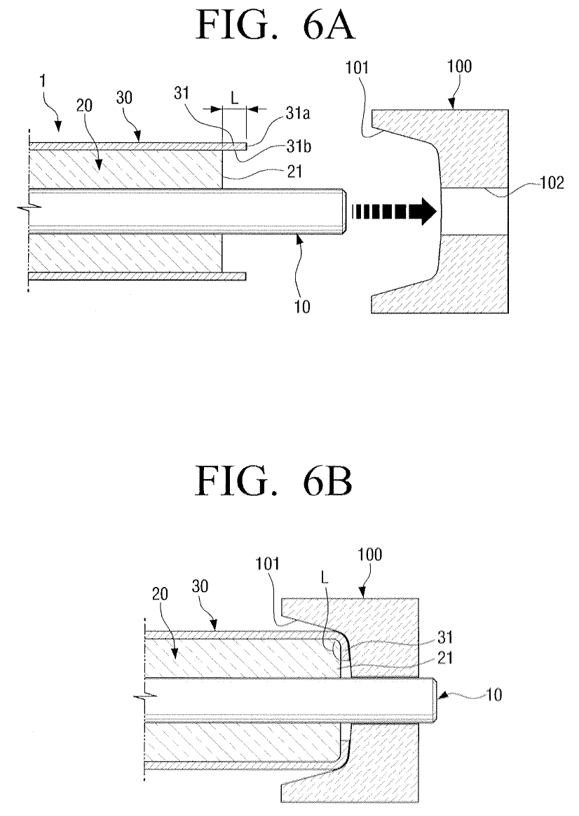

The tube 30 may be formed to have a thickness of about 1 mm to about 4 mm. The tube 30 may be formed to have a thickness thinner than that of the body 20. Also, a surface hardness of the tube 30 may be higher than that of the body 20. So the tube 30 may not be sensitive to the outside environment, and may have a resisting power with respect to deformation, etc. Furthermore, referring to FIG. 6A, a length L of a folded portion, that is, a length L of each of the opposite side end portions 31 of the tube 30 may be about 1 mm or more. Here, the folded portion 31 of the tube 30 corresponds to each of the opposite side end portions 31 of the tube 30 projecting beyond the side surfaces 21 of the body 20 before being folded over the side surfaces 21 of the body 20. Also, the maximum length of the folded portion 31 of the tube 30 may be shorter than the thickness T1 of the body 20. That is, the maximum length of the folded portion 31 of the tube 30 may be limited within a range of the distance from the outer surface 20a of the body 20 to the outer surface 10a of the shaft 10. At this time, the length L of the folded portion 31 of the tube 30 may be determined to have a predetermined size so that the folded portion 31 generates a securing force preventing the tube 30 from moving with respect to the body 20 by rotation of the roller 1.

When the opposite side end portions 31 of the tube 30 are bonded to the opposite side surfaces 21 of the body 20, the tube 30 is cut to have a length longer than that of the body 20 and the opposite side end portions 31 of the tube 30 (hereinafter, refer to projecting portions of the tube) projecting from the opposite side surfaces 21 of the body 20 are bent toward the shaft 10. After this, the inner surface 31b of the projecting portion 31 of the tube 30 is fixed to the side surface 21 of the body 20. At this time, the projecting portion 31 of the tube 30 may be fixed to the side surface 21 of the body 20 using various methods such as adhesives, etc. In an embodiment according to the present general inventive concept, the projecting portion 31 of the tube 30 may be heated and pressurized by a predetermined temperature and pressure, thereby being secured on the side surface 21 of the body 20.

Also, when the projecting portion 31 of the tube 30 is secured on the body 20, a jig may be used. In this embodiment of the present general inventive concept, as illustrated in FIG. 5, a side end attaching jig 100 may be used to allow the projecting portion 31 of the tube 30 to contact the side surface 21 of the body 20 and to apply heat to the projecting portion 31, thereby securing the projecting portion 31 on the side surface 21 of the body 20.

Referring to FIGS. 5, 6A and 6B the side end attaching jig 100 may include a molding surface 101 to mold the projecting portion 31 of the tube 30 and a through hole 102 into which the shaft 10 is inserted. The molding surface 101 may be formed to bend the projecting portion 31 of the tube 30 projecting from the body 20 toward the shaft 10 and to mold the bent projecting portion 31 of the tube 30 in a predetermined shape. Also, although they are not illustrated in the drawings, the side end attaching jig 100 may include a heat unit to heat the projecting portion 31 of the tube 30 by a predetermined temperature and a moving pressure unit to convey the side end attaching jig 100 to the side surface 21 of the body 20 and to pressurize the side end attaching jig 100 by a predetermined pressure.

On the other hand, the opposite side end portions 31 of the tube 30 may be formed in various shapes according to the shape of a corner 21a of the body 20. In this embodiment of the present general inventive concept, the corner 21a of the body 20 may be chamfered in a round or rounding shape (see an upper corner 21a of a section of the body 20 in FIG. 4). Therefore, the opposite side end portions 31 of the tube 30 corresponding to the corner 21a of the body 20 also are formed corresponding to the corner 21a of the body 20 so that a corner of the section of the tube 30 has a round or rounding shape.

If the opposite side end portions 31 of the tube 30 are secured, when the roller 1 rotates, the tube 30 does not move relatively with respect to the body 20 by a driving force of the roller 1. Especially when the roller 1 rotates while contacting another rotating body or a stationary body, the tube 30 is required to be fixed to the body 20 so that the roller 1 can stably perform its functions thereof. For example, the developing roller may contact at least one of a photosensitive medium, a developer supplying roller, or a layer regulating member regulating a developer layer formed on the developing roller. Therefore, if the tube 30 is not fixed on the body 20, at least one problem may occur in an image developing process. When the roller 1 is used as a charging roller, the roller 1 may contact a charged body (for example, a photosensitive medium) or a charge cleaning member (a member capable of cleaning the roller such as a roller, a film, a plate blade, or a brush). If the tube 30 is not fixed on the body 20, at least one problem may occur in a charging process. In case the roller 1 is used as one among a transferring roller, a charge cleaning roller, or a reset roller, if the tube 30 is not fixed on the body 20, at least one problem may occur when the roller 1 performs the original function thereof. Therefore, if the opposite side end portions 31 of the tube 30 are fixed on the body 20 as in the present embodiment, shaking of the roller 1 may be prevented.

Also, if the opposite side end portions 31 of the tube 30 are fixed on the body 20, the securing force between the body 20 and the tube 30 is increased so that the electric resistance of the roller 1 becomes uniform. If an adhesive is not used between the tube 30 and the body 20, when the roller 1 rotates, the tube 30 may move to be temporarily partially separated from the body 20. In general, the tube 30 has an electric resistance relatively higher than the body 20 so that the roller 1 may receive relatively less influence from the outside environment such as temperature, humidity, etc. However, if the tube 30 is temporarily and partially separated from the body 20 during rotation of the roller 1, partial electric resistance of the separated portion is temporarily increased. As a result, the electrical property of the portion is changed so that at least one problem may occur in the property and performance of the roller 1. For example, when the roller 1 is used as a developing roller, the partial resistance is increased so that density of the image is changed. In case the roller 1 is used as a charging roller, when the partial resistance is increased, a charging property of a charged body (for example, a photosensitive medium) is changed so that a problem may occur in images. Also, when the roller 1 is used as one of a transferring roller, a charge cleaning roller, or a reset roller, the same problems may occur. Therefore, if the roller 1 according to an embodiment of the present general inventive concept is used as a charging roller for an image forming apparatus, the charging roller may have a uniform charging ability.

Also, the tube 30 may be formed to have a thickness T2 thinner than the thickness T1 of the body 20. Referring to FIGS. 3 and 4, the thickness T2 of the tube 30 is a distance from the outer surface 20a of the body 20 to the outer surface 30a of the tube 30. The thickness T1 of the body 20 is a distance from the outer surface 10a of the shaft 10 to the outer surface 20a of the body 20. In this embodiment of the present general inventive concept, the sum of the thickness of the body 20 and the diameter of the shaft 10 may be the half of the diameter of the roller 1 or more.

The tube 30 may be formed by either an extrusion molding method using an extruding machine or a press molding method using a press the same as the body 20. When the body 20 in which the shaft 10 is inserted is integrally formed with the tube 30, the tube 30 may be separately manufactured, and then the tube 30 may be inserted into the body 20 having the shaft 10 assembled in a separate process. Also, during the extrusion molding process or the press molding process, the body 20 having the shaft 10 may be inserted in the injection die or the press dies so that the tube 30 may be molded integrally with the body 20.

The tube 30 may be formed of at least one material selected among ethylene propylene diene monomer rubber (EPDM), acrylonitrile butadiene rubber (NBR), polyolefin resin, such as PE, PP, PS, PVC, etc., fluoro based polymeric resin, such as PTFE, ETFE, PFA, PEP, PVF, FPE, etc., and a mixture thereof.

For example, after 55 parts by weight of acrylonitrile butadiene rubber, 45 parts by weight of epichlorohydrine, 5 parts by weight of charge preventing agent, 15 parts by weight of a cross-linking agent, and 2.5 parts by weight of carbon black are mixed, the tube 30 may be manufactured to have a thickness of 2.5±0.5 mm and a surface roughness of Rz 7-11 μm. At this time, the tube 30 may have a hardness of about 40±5 degrees (Asker type-A) and an electric resistance of about 10⁵Ω to about 10⁶Ω.

After the tube 30 is inserted over the body 20 having the shaft 10, manufacturing of the roller 1 is completed. At this time, the electric resistance of the body 20 may be adjusted so that the entire electric resistance of the roller 1 is about 10⁶Ω to about 3.5×10⁶Ω.

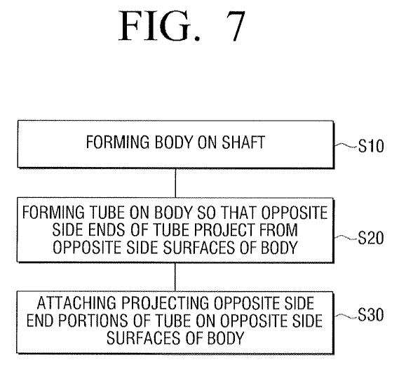

Hereinafter, a method of manufacturing the roller 1 usable with an image forming apparatus according to an embodiment of the present general inventive concept having the structure as described above will be explained in detail with reference to FIGS. 4 and 7.

First, the shaft 10 is formed integrally with the body 20 so that the shaft 10 is located at a center of the body 20 (operation S10). At this time, the shaft 10 may be manufactured in a separate process. After the body 20 is formed in a process separated from the shaft manufacturing process, the shaft 10 may be inserted in the body 20 so that the shaft 10 and the body 20 are formed integrally with each other. Alternatively, the insert molding method may be used. In other words, when the body 20 is formed by the extrusion molding or the press molding, the shaft 10 is inserted in the injection die of the extrusion machine or the press dies so that the shaft 10 and the body 20 is molded in a single body.

Next, the tube 30 is formed integrally with the body 20 on the outer surface 20a of the body 20 (operation S20). At this time, the opposite side ends 31a of the tube 31, as illustrated in FIG. 6A, are formed to project by a predetermined length L from the opposite side ends 21 (or opposite side surfaces) of the body 20. After the tube 30 is formed in a process separated from the body manufacturing process, the tube 30 may be inserted over the outer surface 20a of the body 20 in which the shaft 10 is inserted so that the tube 30 and the body 20 are formed integrally with each other. Alternatively, the insert molding method may be used. In other words, when the tube 30 is formed by the extrusion molding or the press molding, the body 20 having the shaft 10 is inserted in the injection die of the extrusion machine or the press dies so that the tube 30 and the body 20 is molded in a single body. At this time, the opposite side ends 31a of the tube 30 may be formed so that lengths L projecting beyond the opposite side surfaces 21 (or opposite side ends) of the body 20 are the same as each other.

Finally, the projecting opposite side end portions 31 of the tube 30 are folded over and attached on the opposite side surfaces 21 of the body 20 (operation S30). At this time, as illustrated in FIGS. 6A and 6B, the side end attaching jig 100 may be used to allow the projecting portion 31 of the tube 30 to be bent. After that, a predetermined heat may be applied to the side end attaching jig 100 so that the opposite side end portions 31 of the tube 30 are attached on the side surfaces 21 of the body 20.

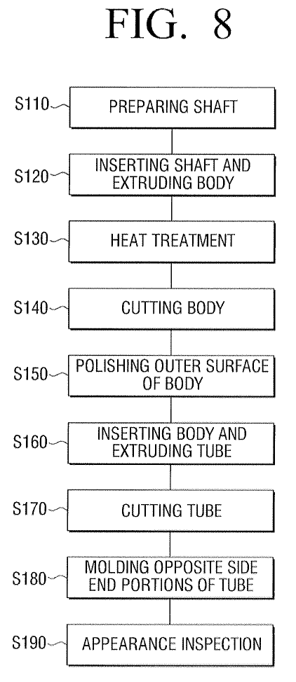

FIG. 8 is a flow chart illustrating a method of manufacturing a developing roller usable with an image forming apparatus using the method of manufacturing a roller according to an embodiment of the present general inventive concept as described above.

Hereinafter, the method of manufacturing a developing roller usable with an image forming apparatus using the method of manufacturing a roller according to an embodiment of the present general inventive concept will be explained in detail with reference to FIG. 8.

First, the shaft 10 is prepared (operation S110). The shaft 10 may be formed of a metallic material in a separate process and may have a predetermined length.

Next, after the shaft 10 is inserted, the body 20 is insert-extruded (operation S120). In other words, the shaft 10 is inserted in the extrusion die (or an injection die) of the extrusion machine for molding the body 20 and the body 20 is extruded by the injection machine so that the shaft 10 and the body 20 are formed integrally with each other.

Then, a heat treatment in that the body 20 in which the shaft 10 is inserted is heated at about 180° C. for about 60 minutes may be performed (operation S130). After the heat treatment the body 20 in which the shaft 10 is inserted is left at the normal temperature.

After that, the body 20 is cut by a predetermined length, and the body 20 in which the shaft 10 is inserted is completed.

Then, the outer surface 20a of the body 20 is polished to have a predetermined roughness (operation S150).

Next, after inserting the body 20 in which the shaft 10 is inserted, the tube 30 is insert-extruded (operation S160). In other words, after the body 20 having the shaft 10 is inserted in the extrusion die of the extrusion machine for molding the tube 30, the extrusion machine extrudes the tube 30 so that the tube 30 is formed integrally with the body 20 having the shaft 10.

After this, the tube 30 is cut by a predetermined length (operation S170), and then the tube 30 in which the shaft 10 and the body 20 are integrally inserted, that is, the developing roller is provided. At this time, the tube 30 may be cut to have a length longer than that of the body 20 so that the opposite side ends 31a of the tube 30 project beyond the opposite side surfaces 21 of the body 20. For example, when the length of the body 20 is 230±0.2 mm, the tube 30 may be cut to have the length of 232±0.2 mm. Then each of the opposite side ends 31a of the tube 30 projects about 1 mm from the opposite side surfaces 21 of the body 20.

Next, the opposite side end portions 31 of the tube 30 are molded (operation S180). At this time, the side end attaching jig 100, as illustrated in FIG. 5, may be used to mold the opposite side end portions 31 of the tube 30. In other words, as illustrated in FIG. 6A, after the side end attaching jig 100 is located at a side of the shaft 10, the side end attaching jig 100, as illustrated in FIG. 6B, is slid over the shaft 10 and is pushed to the side end 21 of the body 20 so that the projecting portion 31 of the tube 30 is bent to the shaft 10 by the molding surface 101 of the side end attaching jig 100 and contacts the side surface 21 of the body 20. In this state, a predetermined heat is applied to the side end attaching jig 100 for a predetermined period of time so that the projecting portion 31 of the tube 30 is secured on the side surface 21 of the body 20. After this, after the side end attaching jig 100 is separated from the shaft 10, molding of the opposite side end portions 31 of the tube 30 is completed. FIGS. 6A and 6B illustrate the side end attaching jig 100 molding only one side end portion 31 of the tube 30. However, the other side end portion 31 of the tube 30 can be molded at the same time by another side end attaching jig 100.

Finally, an appearance inspection is performed with respect to the roller 1 of which the molding of the opposite side end portions 31 of the tube 30 are completed (operation S190).

Although a few embodiments of the present general inventive concept have been illustrated and described, it will be appreciated by those skilled in the art that changes may be made in these embodiments without departing from the principles and spirit of the general inventive concept, the scope of which is defined in the appended claims and their equivalents.

What is claimed is:

1. A roller usable with an image forming apparatus comprising:
a shaft;
a body formed on an outer surface of the shaft; and
a tube disposed on an outer surface of the body, the tube formed so that opposite side end portions of the tube contact opposite side surfaces of the body.

2. The roller usable with an image forming apparatus of claim 1, wherein the opposite side end portions of the tube are heated and pressurized so as to be secured on the opposite side surfaces of the body.

3. The roller usable with an image forming apparatus of claim 2, wherein the opposite side end portions of the tube are formed so that a section of a corner thereof is a round shape.

4. The roller usable with an image forming apparatus of claim 1, wherein the opposite side ends of the tube project by a predetermined length from the opposite side surfaces of the body, and contact the opposite side surfaces of the body,
wherein the predetermined length is within a range between about 1 mm and a distance from an outer surface of the body to an outer surface of the shaft.

5. The roller usable with an image forming apparatus of claim 1, wherein the body is disposed on the shaft by an insert extrusion molding.

6. The roller usable with an image forming apparatus of claim 1, wherein the tube is disposed on the body by an insert extrusion molding.

7. The roller usable with an image forming apparatus of claim 1, wherein the tube is formed of at least one material selected from the group consisting of ethylene propylene diene monomer rubber (EPDM), acrylonitrile butadiene rubber (NBR), polyolefin resin, fluoro based polymeric resin, and any mixture thereof.

8. The roller usable with an image forming apparatus of claim 1, wherein the tube has a hardness higher than that of the body and the hardness of the tube is about 35 to about 45 degrees (Asker type-A).

9. The roller usable with an image forming apparatus of claim 1, wherein an electric resistance of the tube is about 10⁵Ω to about 10⁶Ω, and an entire electric resistance of the roller is about 10⁶Ω to about 3.5×10⁶Ω.

10. The roller usable with an image forming apparatus of claim 1, wherein the tube has a surface roughness of Rz 7-11 μm and a thickness of 2.5±0.5 mm.

11. The roller usable with an image forming apparatus of claim 1, wherein the roller comprises a developing roller, a charging roller, a transferring roller, a charge cleaning roller, and a reset roller.

12. A method of manufacturing a roller usable with an image forming apparatus, the method comprising:
forming a shaft and a body integrally with each other so that the shaft is located at a center of the body;
forming a tube on an outer surface of the body so that opposite side ends of the tube project beyond opposite side surfaces of the body; and
attaching projecting opposite side end portions of the tube to the respective opposite side surfaces of the body.

13. The method of claim 12, wherein the attaching projecting opposite side end portions of the tube on the opposite side surfaces of the body comprises;
using a side end attaching jig so that the projecting opposite side end portions of the tube are deformed and contact the opposite side surfaces of the body; and
applying heat to the side end attaching jig.

14. The method of claim 12, wherein the forming a tube so that opposite side ends of the tube project from opposite side surfaces of the body comprises allowing the opposite side ends of the tube to project from the opposite side surfaces of the body within a range between about 1 mm and a distance from an outer surface of the body to an outer surface of the shaft.

15. The method of claim 12, wherein the forming a shaft and a body integrally with each other comprises an insert extrusion molding in that the shaft is inserted in an extrusion die and the body is extruded.

16. The method of claim 12, wherein the forming a tube on an outer surface of the body comprises an insert extrusion molding in that the body having the shaft is inserted in an extrusion die and the tube is extruded.

17. The method of claim 12, wherein the tube is formed of at least one material selected from the group consisting of ethylene propylene diene monomer rubber (EPDM), acrylonitrile butadiene rubber (NBR), polyolefin resin, fluoro based polymeric resin, and any mixture thereof.

18. The method of claim 12, wherein the roller comprises a developing roller, a charging roller, a transferring roller, a charge cleaning roller, and a reset roller.

19. A roller usable with an image forming apparatus, the roller comprising:
an integrally formed shaft and body, the shaft being formed at and extending out from a center of the body; and
a tube disposed on an outer surface of the body and folded over opposite side end portions of opposite side surfaces of the body by a predetermined amount to be adhered thereto.
